(19) United States
(12) Patent Application Publication
(10) Pub. No.: US 2024/0410639 A1
(43) Pub. Date: Dec. 12, 2024

(54) ARTICULATING DOOR LATCH FOR A BUILT-IN ICEBOX

(71) Applicant: Haier US Appliance Solutions, Inc., Wilmington, DE (US)

(72) Inventors: William Jeremy Leachman, Louisville, KY (US); Shelby Breeze, Louisville, KY (US); John Conrad, Louisville, KY (US)

(21) Appl. No.: 18/330,406

(22) Filed: Jun. 7, 2023

(51) Int. Cl. F25D 23/02; E05C 3/00; E05C 3/04

(52) U.S. Cl. CPC F25D 23/028; E05C 3/004; E05C 3/045

(57) ABSTRACT

A refrigerator appliance includes a cabinet forming a receiving space; a door to provide selective access to the receiving space; an icebox at least partially received within the receiving space; an icebox door providing selective access to the icebox; and a latch rotatably coupled to the icebox door to selectively secure the icebox door to the icebox. The latch includes a main body defining a pivot point; a handle attached to the main body; a latch hook spaced apart from the pivot point along the radial direction by a first distance and extending clockwise along the circumferential direction; and a hammer spaced apart from the pivot point along the radial direction opposite the latch hook by a second distance shorter than the first distance, the hammer extending counterclockwise along the circumferential direction.

### FIELD OF THE INVENTION

The present subject matter relates generally to refrigerator appliances, and more particularly to icebox and icebox doors within refrigerator appliances.

### BACKGROUND OF THE INVENTION

Certain refrigerator appliances include an ice maker or ice making assembly. A variety of ice types can be produced depending upon the particular ice maker used. Ice making assemblies are typically mounted in an icebox compartment and receive cooling air from a sealed system to assist with the formation or maintenance (e.g., in a frozen state) of ice. The cooling air is supplied into the icebox compartment through a supply duct and a return duct formed in the side of the icebox compartment. The ice making assemblies include an inlet which must be positioned over the supply duct and an outlet which must be positioned over the return duct.

The icebox typically includes a door to provide selective access into the icebox compartment to retrieve ice therein. The icebox door may be movably fixed to the icebox itself. For instance, the icebox door can be rotatable with respect to the icebox. Accordingly, a handle or coupling device may be included on the icebox door to maintain the door in a closed position. However, current devices have multiple drawbacks. For instance, due to the cooling air supplied to the icebox in comparison to the relatively warmer air within the refrigerator appliance may lead to frost formation between the icebox and the icebox door. Such frost may lead to attaching devices being frozen in place between the icebox and the icebox door. For another example, the frost binds a gasket between the icebox door and the icebox leading to excessive force being required to open the icebox door to overcome the frost.

Accordingly, a refrigerator appliance that obviates one or more of the above-mentioned drawbacks would be desirable. In particular, an icebox door including features for easily opening the icebox door with respect to the icebox would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a refrigerator appliance is provided. The refrigerator appliance may include a cabinet forming a receiving space; a door to provide selective access to the receiving space; an icebox at least partially received within the receiving space; an icebox door providing selective access to the icebox; and a latch rotatably coupled to the icebox door to selectively secure the icebox door to the icebox, the latch defining an axial direction, a radial direction, and a circumferential direction. The latch may include a main body defining a pivot point; a handle attached to the main body; a latch hook spaced apart from the pivot point along the radial direction by a first distance and extending clockwise along the circumferential direction; and a hammer spaced apart from the pivot point along the radial direction opposite the latch hook by a second distance shorter than the first distance, the hammer extending counterclockwise along the circumferential direction.

In another exemplary aspect of the present disclosure, an icebox is provided. The icebox may include a frame defining a storage space; an icebox door movably coupled to the frame and providing selective access to the storage space; and a latch rotatably coupled to the icebox door to selectively secure the icebox door to the frame, the latch defining an axial direction, a radial direction, and a circumferential direction. The latch may include a main body defining a pivot point; a handle attached to the main body; a latch hook spaced apart from the pivot point along the radial direction by a first distance and extending clockwise along the circumferential direction; and a hammer spaced apart from the pivot point along the radial direction opposite the latch hook by a second distance shorter than the first distance, the hammer extending counterclockwise along the circumferential direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present disclosure.

FIG. 2 provides a perspective view of a door of the exemplary refrigerator appliance of FIG. 1.

FIG. 3 provides an elevation view of the door of the exemplary refrigerator appliance of FIG. 2 with an access door of the door shown in an open position.

FIG. 4 provides a close-up, side cut-away view of a latch of the access door of FIG. 3 in a closed position.

FIG. 5 provides a side perspective view of the access door of FIG. 4 including the latch in an open position.

FIG. 6 provides a perspective view of the latch of FIG. 4.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

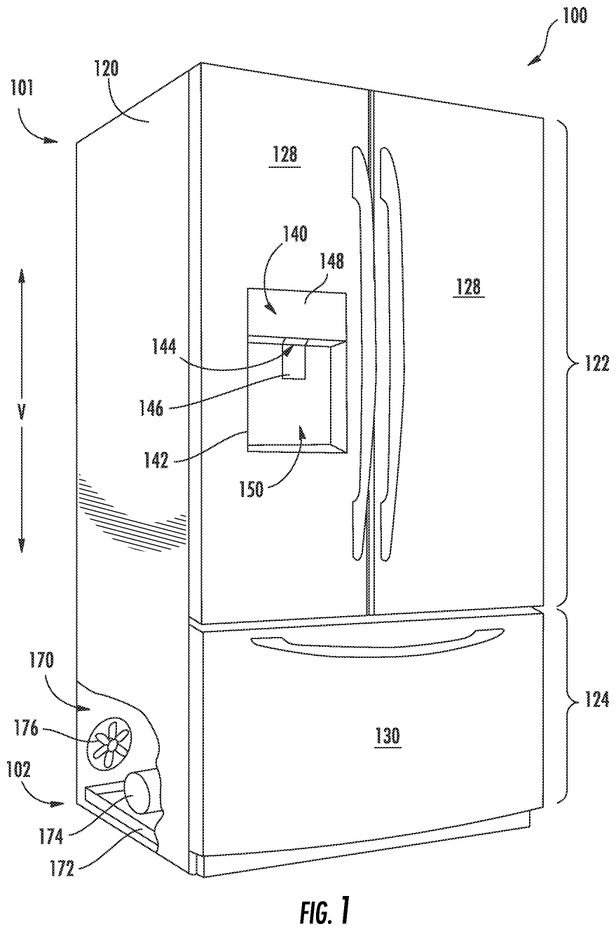

FIG. 1 provides a perspective view of a refrigerator appliance 100 according to an exemplary embodiment of the present subject matter. Refrigerator appliance 100 may include a cabinet or housing 120 that extends between a top portion 101 and a bottom portion 102 along a vertical direction V. Housing 120 defines chilled chambers for receipt of food items for storage. In particular, housing 120 defines fresh food chamber or receiving space 122 positioned at or adjacent top portion 101 of housing 120 and a freezer chamber or receiving space 124 arranged at or adjacent bottom portion 102 of housing 120. As such, refrigerator appliance 100 shown in the FIGS is generally referred to as a bottom mount refrigerator. It should be recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 128 may be rotatably hinged to an edge of housing 120 for selectively accessing fresh food chamber 122. In addition, a freezer door 130 may be arranged below refrigerator doors 128 for selectively accessing freezer chamber 124. Freezer door 130 may be coupled to a freezer drawer (not shown) slidably mounted within freezer chamber 124. Refrigerator doors 128 and freezer door 130 are shown in the closed configuration in FIG. 1.

Refrigerator appliance 100 may also include a dispensing assembly 140 for dispensing liquid water and/or ice. Dispensing assembly 140 may include a dispenser 142 positioned on or mounted to an exterior portion of refrigerator appliance 100, e.g., on one of refrigerator doors 128. Dispenser 142 may include a discharging outlet 144 for accessing ice and liquid water. An actuating mechanism 146, shown as a paddle, may be mounted below discharging outlet 144 for operating dispenser 142. In alternative exemplary embodiments, any suitable actuating mechanism may be used to operate dispenser 142. For example, dispenser 142 can include a sensor (such as an ultrasonic sensor) or a button in addition to or alternatively from the paddle. A user interface panel 148 may be provided for controlling the mode of operation. For example, user interface panel 148 may include a plurality of user inputs (not labeled), such as a water dispensing button and an ice-dispensing button, for selecting a desired mode of operation such as crushed or non-crushed ice.

Discharging outlet 144 and actuating mechanism 146 are an external part of dispenser 142 and may be mounted in a dispenser recess 150. Dispenser recess 150 may be positioned at a predetermined elevation convenient for a user to access ice or water and enabling the user to access ice without the need to bend-over and without the need to open doors 128. In the exemplary embodiment, dispenser recess 150 is positioned at a level that approximates the chest level of a user.

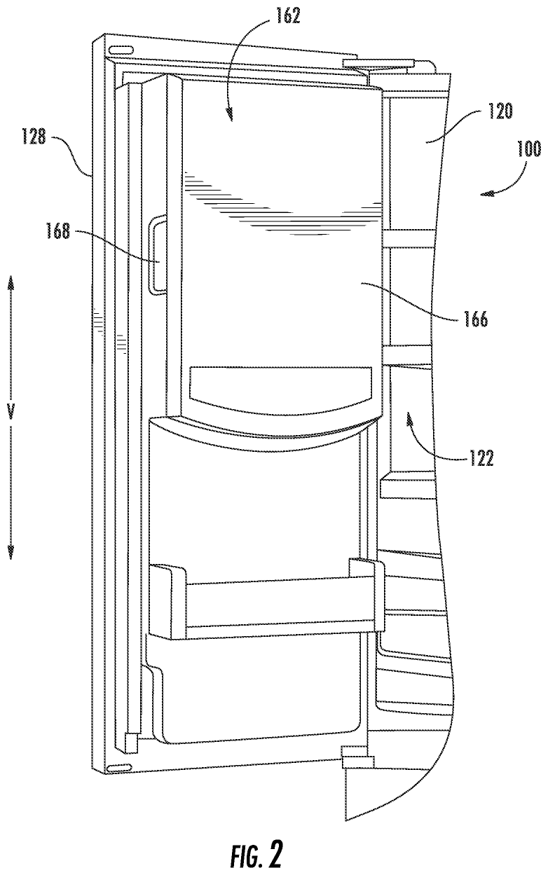

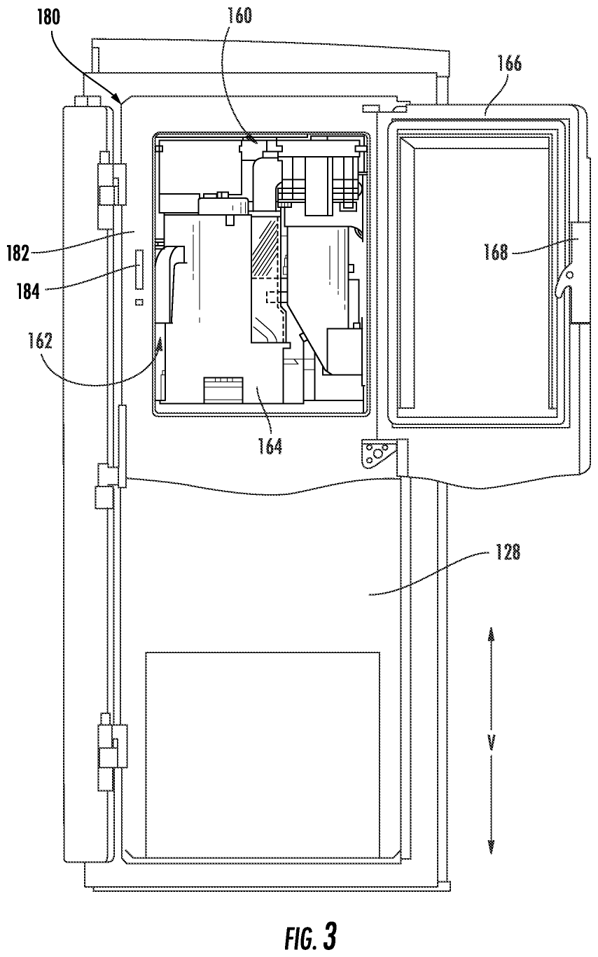

FIG. 2 provides a perspective view of a door of refrigerator doors 128. FIG. 3 provides an elevation view of refrigerator door 128 with an access door (or icebox door) 166 shown in an open position. Refrigerator appliance 100 may include a freezer sub-compartment 162, often referred to as an “icebox compartment,” defined on refrigerator door 128. Icebox compartment 162 may extend into fresh food chamber 122 when refrigerator door 128 is in the closed position. Accordingly, icebox compartment (or icebox) 162 may be at least partially provided within fresh food chamber 122.

Icebox compartment 162 may be constructed of or with a suitable plastic material. According to the exemplary embodiment, icebox compartment 162 may be formed of injection molded plastic. For example, icebox compartment 162 may be injection-molded plastic such as HIPS (high impact polystyrene—injection molding grade) or ABS (injection molding grade). Accordingly, icebox compartment 162 provides a rigid frame (e.g., frame 180, described below) on which various elements can be mounted, such as an ice making assembly and storage bins.

As may be seen in FIG. 3, an ice maker or ice making assembly 160 and an ice storage bin or ice bucket 164 may be positioned or disposed within icebox compartment 162. Thus, ice may be supplied to dispenser recess 150 (FIG. 1) from the ice making assembly 160 and/or ice bucket 164 in icebox compartment 162 on a back side of refrigerator door 128.

Access door (or icebox door) 166 may be hinged to refrigerator door 128. Access door 166 permits selective access to icebox compartment 162 and ice making assembly 160, e.g., for servicing or repairing ice making assembly 160. Additionally or alternatively, icebox door 166 may be selectively coupled to refrigerator door 128 in other suitable manners, such as withdrawable (e.g., via one or more slides), slidably, or the like. A latch 168 may be configured with icebox compartment 162 (e.g., as part of icebox door 166) to maintain icebox door 166 in a closed position. For instance, latch 168 may be actuated by a consumer in order to open icebox door 166 for providing access into freezer sub-compartment 162, as will be explained in further detail below. Icebox door 166 may also assist with insulating icebox compartment 162. For instance, a gasket (not shown) may be provided between icebox compartment 162 and icebox door 166 to create a seal therebetween when icebox door 166 is in a closed position.

Icebox compartment 162, which may hereinafter be referred to as an icebox, may include a frame 180. According to at least some embodiments, frame 180 may be defined at least in part by refrigerator door 128. For instance, as mentioned above, icebox compartment 162 may be formed within refrigerator door 128 (e.g., as a cavity). Frame 180 may thus define a contact wall 182 to selectively contact icebox door 166 (e.g., when icebox door 166 is in the closed position). Contact wall 182 may be defined along the vertical direction V and a horizontal direction (e.g., one of the lateral direction L and the transverse direction T). For instance, when refrigerator door 128 and icebox door 166 are each in the closed position, contact wall 182 is defined along the vertical direction V and the lateral direction L. The gasket may thus be provided between contact wall 182 and icebox door 166.

A catch groove 184 may be defined in contact surface 182. For instance, catch groove 184 may be recessed into contact surface 182 (e.g., away from icebox door 166 when in the closed position along the horizontal direction). Catch groove may extend generally along the vertical direction V and the horizontal direction (e.g., lateral direction L or transverse direction T). Catch groove 184 may form a receiving space 186 for acceptance of latch 168. For instance, at least a portion of latch 168 may be selectively received within receiving space 186 of catch groove 184 to maintain icebox door 166 in the closed position.

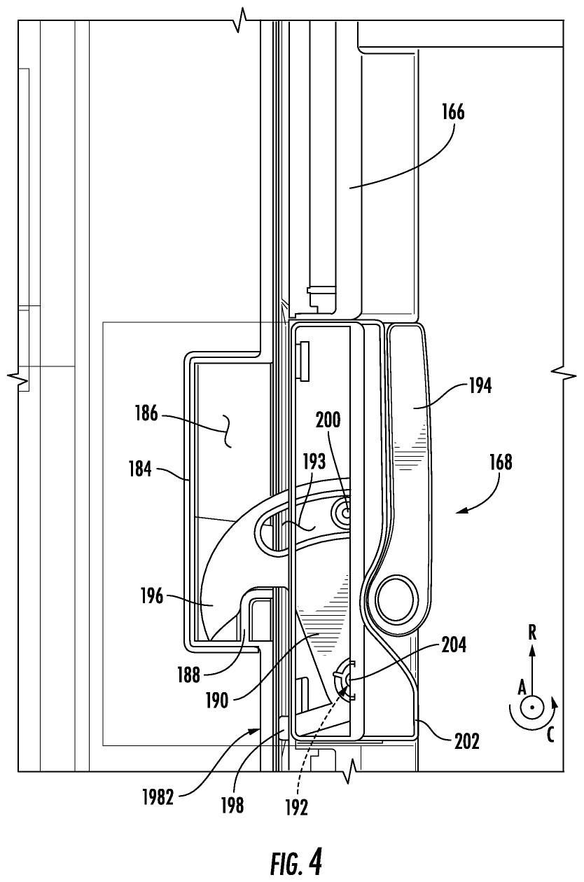

Catch groove 184 may further include a lip 188. Lip 188 may protrude inward into catch groove 184 (e.g., along the transverse direction T when refrigerator door 128 is in the closed position). Lip 188 may be formed at or near a bottom of catch groove 184. Referring briefly to FIG. 4, lip 188 may extend along the vertical direction V. Thus, a vertically recessed portion of catch groove 184 (e.g., receiving space 186) may be formed behind lip 188 (e.g., along the transverse direction T when refrigerator door 128 is in the closed position). As will be described, at least a portion of latch 168 is selectively received behind lip within the vertically recessed portion of catch groove 184 such that icebox door 168 is latched to refrigerator door 128 in the closed position.

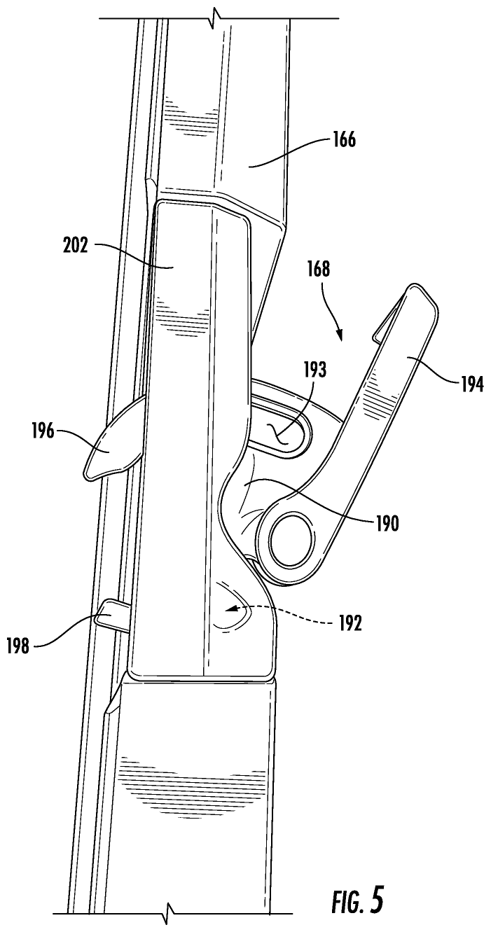

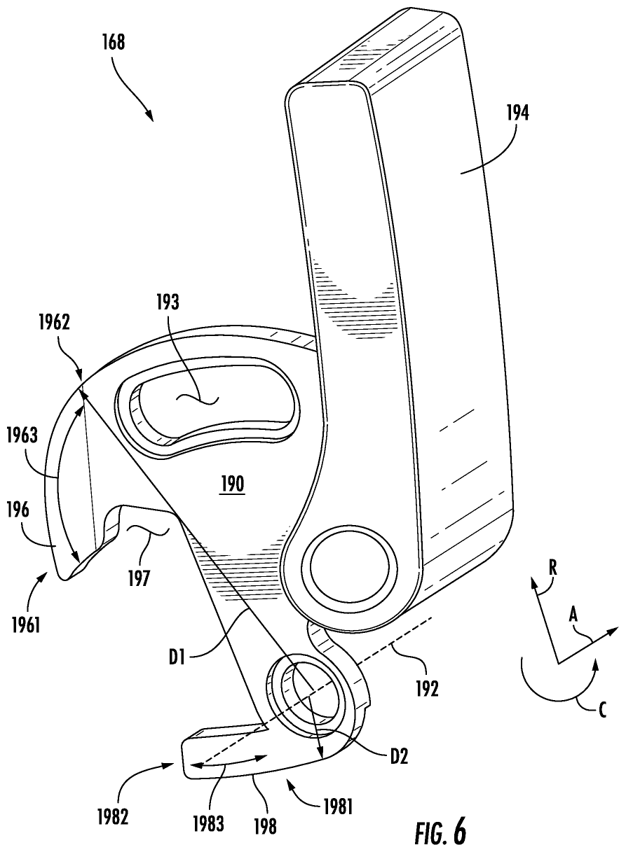

Referring now generally to FIGS. 4 through 6, latch 168 will be described in detail. For instance, latch 168 may define an axial direction A, a radial direction R, and a circumferential direction C. For reference, axial direction A may be generally parallel to the horizontal direction (e.g., lateral direction L or transverse direction T). Latch 168 may include a main body 190. Main body 190 may be generally plate-shaped (e.g., extending along the radial direction R). For instance, main body 190 may define a pivot point 192. Latch 168 may selectively rotate about pivot point 192. Hereinafter, pivot point 192 may be referred to as a pivot axis (e.g., pivot axis 192 as shown in FIG. 6). Pivot point 192 may be formed as an axial aperture through main body 190 (e.g., along the axial direction A). Accordingly, latch 168 may selectively rotate along the circumferential direction C (e.g., according to a force or input thereto) about pivot axis or pivot point 192.

Main body 190 may define an elongated aperture 193 therethrough (e.g., parallel with the axial direction A). Elongated aperture 193 may be spaced apart from pivot point 192 (e.g., along the radial direction R). Additionally or alternatively, elongated aperture 193 may extend along the circumferential direction C. For instance, as shown most clearly in FIG. 6, elongated aperture 193 may be provided distal to pivot point 192 along the radial direction and define a circumferential length. Accordingly, elongated aperture 193 may assist in guiding a rotational movement of latch 168 as latch 168 rotates about pivot point 192.

Latch 168 may further include a handle 194. Handle 194 may be attached to main body 190. Handle 194 may extend along the radial direction R. For instance, handle 194 may be provided along an edge of main body 190. As seen in FIG. 4, handle 194 may be provided outside of icebox 162 (e.g., along an exterior of icebox door 166). Accordingly, a user may manipulate handle 194 to selectively release latch 168 from frame 180 (e.g., from catch groove 184). As the user pulls handle 194, a portion of latch 168 is released from receiving space 186 to allow icebox door 166 to rotate, slide, or otherwise disengage from frame 180 (or refrigerator door 128).

Latch 168 may include a latch hook 196. Latch hook 196 may be formed at or near the distal end of main body 190. For instance, latch hook 196 may be spaced apart from pivot point 192 along the radial direction R. Latch hook 196 may be spaced apart from pivot point by a first radial distance D1. In detail, latch hook may define a proximal end 1961 and a distal end 1962. Proximal end 1961 may be provide at the first radial distance D1 from pivot point (or pivot axis) 192.

Latch hook 196 may extend generally along the circumferential direction C. For instance, latch hook 196 may have an extension length 1963 along the circumferential direction C (e.g., between proximal end 1961 and distal end 1962). According to some embodiments, latch hook 196 forms a pocket 197. For instance, pocket 197 may be formed between latch hook 196 and main body 190. Pocket 197 may be formed such that lip 188 is selectively received within pocket 197 when icebox door 166 is in the closed position. Accordingly, as shown in FIG. 4, latch hook 196 is accepted within the vertically recessed portion of catch groove 184.

Latch hook 196 may be spaced apart (e.g., along the circumferential direction C) from elongated aperture 193. Additionally or alternatively, latch hook 196 may extend along a first circumferential direction. The first circumferential direction may be away from handle 194, for instance. In some embodiments, for reference, the first circumferential direction may be defined as clockwise. However, it should be noted that the extending direction is used herein by reference only, and that the extending direction may be counterclockwise depending on a viewing direction thereof.

Latch 168 may include a hammer 198. Hammer 198 may be spaced apart from pivot point (or pivot axis) along the radial direction R. For instance, hammer 198 may be provided predominantly opposite latch hook 196 along the radial direction R. In detail, hammer 198 may include a proximal end 1981 and a distal end 1982. Proximal end 1981 may be spaced apart from pivot point (or pivot axis) 192 by a second radial distance D2. The second radial distance D2 may be less than the first radial distance D1. According to at least some embodiments, a ratio of D1 to D2 is between about 3:1 and about 6:1. Accordingly, a moment arm of hammer 198 may be shorter than a moment arm of latch hook 196.

Hammer 198 may extend generally along the circumferential direction C. Hammer 198 may define a second extension length 1983 (e.g., between proximal end 1981 and distal end 1982). Second extension length 1983 of hammer 198 may be less than extension length 1963 of latch hook 196. For instance, hammer 198 may extend circumferentially in an opposite direction from latch hook 196. As described above, latch hook 196 may extend in the clockwise direction. Accordingly, hammer 198 may extend in the counterclockwise direction. As would be understood, latch hook 196 may extend in the counterclockwise direction while hammer 198 extend in the clockwise direction. Accordingly, latch hook 196 and hammer 198 may extend generally toward each other along the circumferential direction C.

Distal end 1982 of hammer 198 may selectively contact frame 180 of icebox 162. For instance, hammer 198 may press against frame 180 (or refrigerator door 128 according to some embodiments) when latch 168 is rotated (e.g., via handle 194). With reference to FIG. 4, distal end 1982 of hammer 198 may contact icebox 162 at a position below catch groove 184 (e.g., along the vertical direction V with respect to refrigerator door 128) when icebox door 166 is in the closed position. According to some embodiments, distal end 1982 of hammer 198 may be spaced apart from frame 180 by a predetermined amount. Advantageously, hammer 198 may not freeze to frame 180 during an elongated period in the closed position.

During an operation of latch 168 (e.g., via handle 194), main body 190 may rotate about pivot axis 192. As main body 190 rotates, distal end 1982 of hammer 198 presses against frame 180 (e.g., of icebox 162 or refrigerator door 128) along the horizontal direction (e.g., transverse direction T). An outward (e.g., horizontal) force may be generated by hammer 198 against frame 180. Simultaneously, as main body 190 rotates about axis of rotation 192, latch hook 196 rotates upward and outward from receiving space 186 of catch groove 184. Advantageously, the force generated by hammer 198 may ensure that icebox door 166 rotates (or slides, etc.) away from frame 180 without undue stress or flexion being placed on latch 168 (e.g., handle 194).

Icebox door 166 may include a guide pin 200. Guide pin 200 may project along the horizontal direction (e.g., along the lateral direction L when refrigerator door 128 is in the closed position). For instance, guide pin 200 may be configured to penetrate latch 168. Guide pin 200 may pass through elongated aperture 193 (e.g., along the horizontal direction). Guide pin 200 may thus guide the rotational movement of latch 168.

Refrigerator appliance 100 may include a handle cover 202. Handle cover 202 may be selectively fastened to icebox door 166. For instance, handle cover 202 may be coupled to icebox door 166 via a snap fit, one or more fasteners, an adhesive, or any suitable connection means. Latch 168 may be positioned between icebox door 166 and handle cover 202 (e.g., along the horizontal direction such as the lateral direction L). Accordingly, handle cover 202 may accommodate latch 168 therebetween. Additionally or alternatively, latch 168 may selectively rotate with respect to handle cover 202 and icebox door 166.

Handle cover 202 may include a boss 204. Boss 204 may protrude along the horizontal direction (e.g., the lateral direction L when refrigerator door 128 is in the closed position). Boss 204 may penetrate latch 168 (e.g., main body 190) at pivot point (or pivot axis) 192. Accordingly, boss 204 may be colinear with pivot axis 192. Thus, latch 168 may pivot about boss 204. Boss 204 may extend through latch 168 and contact icebox door 166. Accordingly, boss 204 may create a stable rotation axle about which latch 168 rotates.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction and a horizontal direction, the refrigerator appliance comprising:
a cabinet forming a receiving space;
a door to provide selective access to the receiving space;
an icebox at least partially received within the receiving space;
an icebox door providing selective access to the icebox; and
a latch rotatably coupled to the icebox door to selectively secure the icebox door to the icebox, the latch defining an axial direction, a radial direction, and a circumferential direction, wherein the latch comprises:
a main body defining a pivot point;
a handle attached to the main body;
a latch hook spaced apart from the pivot point along the radial direction by a first distance and extending clockwise along the circumferential direction; and
a hammer spaced apart from the pivot point along the radial direction opposite the latch hook by a second distance shorter than the first distance, the hammer extending counterclockwise along the circumferential direction.

2. The refrigerator appliance of claim 1, wherein the icebox defines a contact wall selectively contacting the icebox door.

3. The refrigerator appliance of claim 2, wherein the contact wall defines a catch groove formed therein, the catch groove forming a receiving space for acceptance of the latch hook.

4. The refrigerator appliance of claim 1, wherein an extension length of the hammer along the circumferential direction is less than an extension length of the latch hook along the circumferential direction.

5. The refrigerator appliance of claim 1, wherein the latch further comprises:
an aperture defined through the main body along the axial direction and elongated along the circumferential direction.

6. The refrigerator appliance of claim 5, wherein the icebox door further comprises:
a guide pin projecting along the horizontal direction, the guide pin protruding through the aperture of the latch to guide a rotational movement of the latch.

7. The refrigerator appliance of claim 1, further comprising:
a handle cover fastened to the icebox door, wherein the latch is provided between the icebox door and the handle cover.

8. The refrigerator appliance of claim 7, wherein the handle cover comprises a boss protruding along the horizontal direction toward the icebox door.

9. The refrigerator appliance of claim 8, wherein the boss penetrates the latch at the pivot point such that the latch pivots about the boss.

10. An icebox defining a vertical direction and a horizontal direction, the icebox being integrally formed in a refrigerator appliance, the icebox comprising:
a frame defining a storage space;
an icebox door movably coupled to the frame and providing selective access to the storage space; and
a latch rotatably coupled to the icebox door to selectively secure the icebox door to the frame, the latch defining an axial direction, a radial direction, and a circumferential direction, wherein the latch comprises:
a main body defining a pivot point;
a handle attached to the main body;
a latch hook spaced apart from the pivot point along the radial direction by a first distance and extending clockwise along the circumferential direction; and
a hammer spaced apart from the pivot point along the radial direction opposite the latch hook by a second distance shorter than the first distance, the hammer extending counterclockwise along the circumferential direction.

11. The icebox of claim 10, wherein the icebox defines a contact wall selectively contacting the icebox door.

12. The icebox of claim 11, wherein the contact wall defines a catch groove formed therein, the catch groove forming a receiving space for acceptance of the latch hook.

13. The icebox of claim 10, wherein an extension length of the hammer along the circumferential direction is less than an extension length of the latch hook along the circumferential direction.

14. The icebox of claim 10, wherein the latch further comprises:
an aperture defined through the main body along the axial direction and elongated along the circumferential direction.

15. The icebox of claim 14, wherein the icebox door further comprises:
a guide pin projecting along the horizontal direction, the guide pin protruding through the aperture of the latch to guide a rotational movement of the latch.

16. The icebox of claim 10, further comprising:
a handle cover fastened to the icebox door, wherein the latch is provided between the icebox door and the handle cover.

17. The icebox of claim 16, wherein the handle cover comprises a boss protruding along the horizontal direction toward the icebox door.

18. The icebox of claim 17. wherein the boss penetrates the latch at the pivot point such that the latch pivots about the boss.
